(19) United States
(12) Patent Application Publication
(10) Pub. No.: US 2008/0046731 A1
(43) Pub. Date: Feb. 21, 2008

(54) CONTENT PROTECTION SYSTEM

(76) Inventor: Chung-Ping Wu, Fremont, CA (US)

Correspondence Address: SINORICA, LLC, 528 FALLSGROVE DRIVE, ROCKVILLE, MD, 20850, US

(21) Appl. No.: 11/464,185

(22) Filed: Aug. 11, 2006

(51) Int. Cl. H04L 9/00

(52) U.S. Cl. 713/171

(57) ABSTRACT

A content protection system for securely delivering audio/video data from a content server to a content client through an unsecured channel is disclosed. For each session, the content protection system comprises two phases. The first phase is client-server mutual authentication and session key establishment. In this phase, the content server and the content client verify each other's legitimacy, and at the same time exchange information so that both server and client can calculate or derive the same session key. In the second phase, audio/video data is encrypted with the session key in the content server, and then decrypted with the session key in the content client. If a version of server or client is found to be compromised, its ID will be put into a blacklist.

### BACKGROUND OF THE INVENTION

1. Field of the Invention

The present invention relates to content protection systems. More specifically, the present invention discloses a digital content protection system that allows audio and video data to be securely delivered from a content server to a content client.

2. Description of the Prior Art

As the internet continues increasing in robustness, a growing number of content providers are supplying multimedia to users. Users are able to view the multimedia in streaming format rather than downloading an entire file. However, this method of content delivery has several disadvantages or challenges.

For one, the internet connection must be of suitable bandwidth to accommodate the data transfer. Insufficient bandwidth usually results in jerky video playback.

Additionally, if a channel is unsecured, a hacker could intercept all communication between the content server and the content client. A re-play attack is where the hacker records all communicated data in one session, and then the hacker impersonates the content server and feeds the recorded data to a content client in another session.

If a hacker successfully records the media content and is able to impersonate a content server, the content provider will lose potential revenue that would be normally generated by distributing the media content to a client.

Furthermore, the media content may contain sensitive, classified information, private information, trade secrets, or content that is intended for viewing only by the intended client. Lack of implementing proper protection procedures could allow the media content to fall into inappropriate hands.

Moreover, once the media content is out of the content provider's control, the media can easily be re-distributed.

Therefore there is need for a system to protect multimedia content when multimedia data is delivered through an unsecured channel.

### SUMMARY OF THE INVENTION

To achieve these and other advantages and in order to overcome the disadvantages of the conventional method in accordance with the purpose of the invention as embodied and broadly described herein, the present invention provides a content protection system for securely delivering audio/video data from a content server to a content client through an unsecured channel.

The content server and the content client can be either hardware or software modules. If the channel is unsecured, a hacker could intercept all communication between the content server and the content client. The system of the present invention not only stops the hacker from getting clear-text data, but also prevents a re-play attack.

For each session, the content protection system of the present invention is composed of two phases. The first phase is client-server mutual authentication and session key establishment. In this phase, the content server and the content client verify each other's legitimacy, and at the same time exchange information so that both server and client can calculate/derive the same session key. In the second phase, audio/video data is encrypted with the session key in the content server, and then decrypted with the session key in the content client.

The present invention employs symmetric ciphers as its components. An advantage of the content protection system is that well-known ciphers are used instead of designing a new one. For example, a 128 bit AES cipher can be used because its security is well trusted and it could be implemented in software with fast-computation and in hardware with low gate-count. Alternatively, the cipher could also be other block ciphers, such as DES, Blowfish, or RC4, etc.

Additionally, if a version of server or client is found to be compromised, its ID will be put into a blacklist. Every server and client contains this blacklist, and this list is periodically updated. If a server finds a client's identification number is in the blacklist, it will terminate the session. If a client finds a server's identification number is in the blacklist, it will terminate the session.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a diagram illustrating client and server communication flow according to an embodiment of the present invention;

FIG. 1B is a flowchart illustrating an authentication process according to an embodiment of the present invention;

FIG. 1C is a flowchart illustrating a session key establishment process according to an embodiment of the present invention;

FIGS. 2A-2C are flowcharts illustrating digital content encryption/decryption processes according to embodiments of the present invention; and

FIG. 3 is a flowchart illustrating a revocation process according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

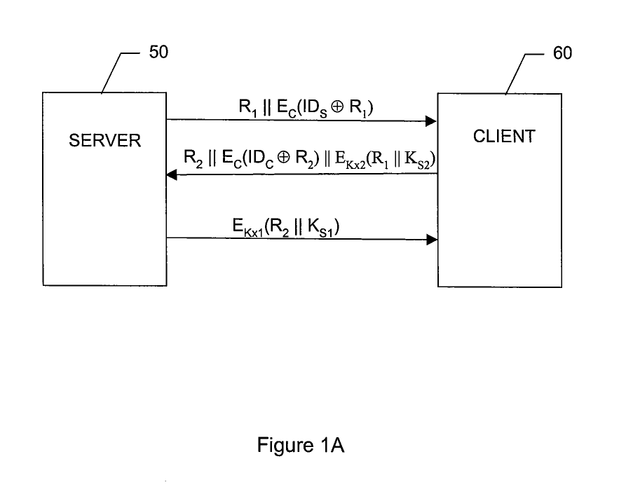

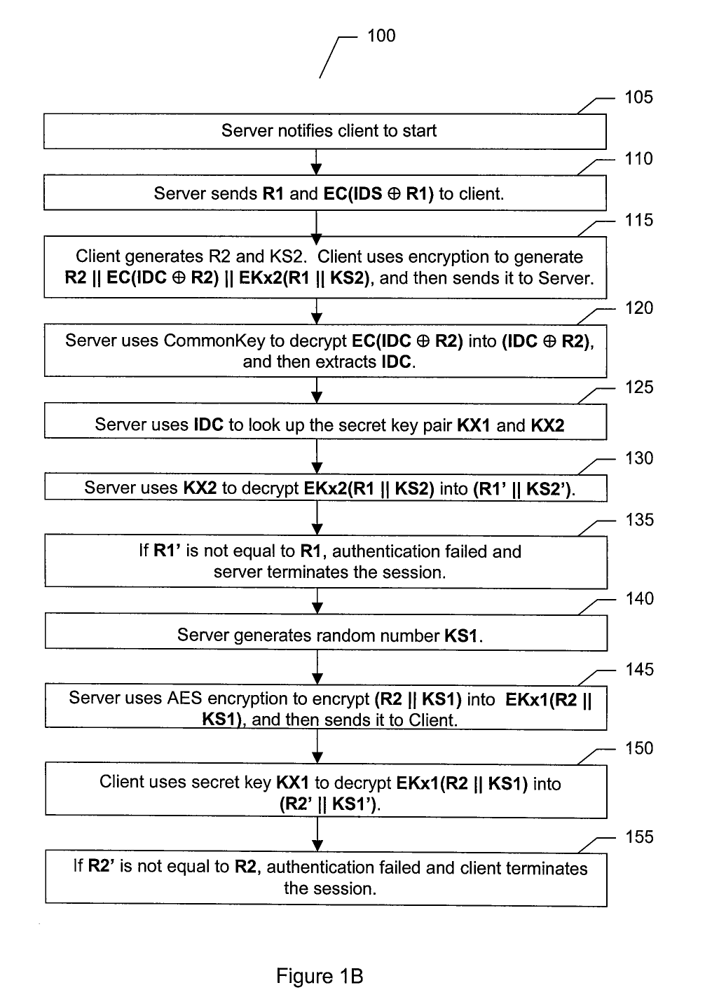

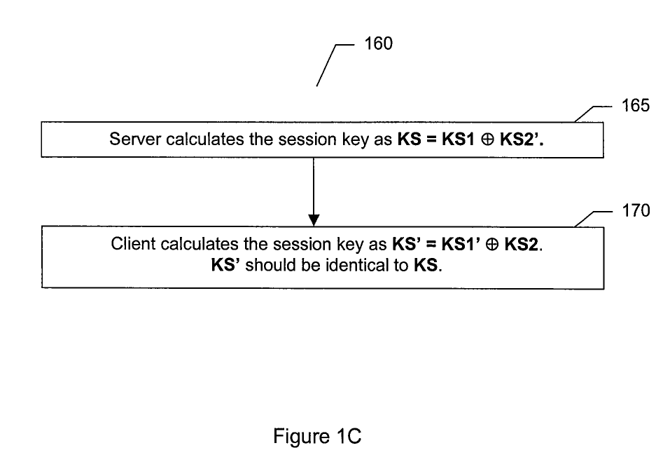

Refer to FIG. 1A, which is a diagram illustrating client and server communication flow according to an embodiment of the present invention and to FIG. 1B, which is a flowchart illustrating an authentication process according to an embodiment of the present invention.

The first phase of the content protection system of the present invention comprises client-server mutual authentication and session key establishment. The challenge/response process as depicted allows the server 50 and the client 60 authenticate each other, and also establishes a session key. The symbols used in the process are first defined as follows:
∥ Concatenation
⊕ XOR
R₁ A 128 bit random number generated by the server.
R₂ A 128 bit random number generated by the client.
K_{X1}, K_{X2} A pair of 128-bit secret keys that the client and the server will use to secure the data exchanged during mutual authentication and session key establishment. Both server and client have this pair of keys embedded inside.
ID_{S} A 128 bit identification number of the server. Server proposes this number to client, so that client knows which server it is dealing with. Each version of server has a unique ID. All instances of the same version share the same ID.
ID_{C} A 128 bit identification number of the client. Client proposes this number to server, so that server could know which secret keys should be used. Each version of client has a unique ID. All instances of the same version share the same ID.
E_{Kx1}( ) AES encryption using the secret key K_{X1}.
E_{Kx2}( ) AES encryption using the secret key K_{X2}.
E_{C}( ) AES encryption using the CommonKey. CommonKey key is a fixed 128 bit number that all versions of servers and clients know.
K_{S1} A 128 bit random number generated by server. It is used as part of the session key.
K_{S2} A 128 bit random number generated by client. It is used as part of the session key.
K_{S} The session key

As shown in FIG. 1A and FIG. 1B, steps of the authentication process 100 comprises:
Step 105 Server 50 notifies client 60 to start the authentication process.
Step 110 Server 50 sends random number R₁ and E_{C}(ID_{S} ⊕ R₁) to client 60.
Step 112 Client 60 uses the CommonKey to decrypt E_{C}(ID_{S} ⊕ R₁) into (ID_{S} ⊕ R₁), and then extracts ID_{S}.
Step 113 Client 60 uses ID_{S} to look up the secret key pair K_{X1} and K_{X2}
Step 115 Client 60 generates random numbers R₂ and K_{S2}. Client 60 uses AES encryption to generate the sequence R₂ ∥ E_{C}(ID_{C} ⊕ R₂) ∥ E_{Kx2}(R₁ ∥ K_{S2}), and then sends it to Server 50.
Step 120 Server 50 uses the CommonKey to decrypt E_{C}(ID_{C} ⊕ R₂) into (ID_{C} ⊕ R₂), and then extracts ID_{C}.
Step 125 Server 50 uses ID_{C} to look up the secret key pair K_{X1} and K_{X2}
Step 130 Server 50 uses K_{X2} to decrypt E_{Kx2}(R₁ ∥ K_{S2}) into (R₁′ ∥ K_{S2}′).
Step 135 If R₁′ is not equal to R₁, authentication failed and server 50 terminates the session.
Step 140 Server 50 generates random number K_{S1}.
Step 145 Server 50 uses AES encryption to encrypt (R₂ ∥ K_{S1}) into E_{Kx1}(R₂ ∥ K_{S1}), and then sends it to Client 60.
Step 150 Client 60 uses secret key K_{X1} to decrypt E_{Kx1}(R₂ ∥ K_{S1}) into (R₂′ ∥ K_{S1}′).
Step 160 If R₂′ is not equal to R₂, authentication failed and client 60 terminates the session.

Refer to FIG. 1C, which is a flowchart illustrating a session key establishment process 160 according to an embodiment of the present invention. After the process illustrated in FIG. 1B is done and the session wasn't terminated by server or client, mutual authentication has succeeded. In order to establish the session key, the server and client perform the following steps:
Step 165 Server calculates the session key as K_{S}=K_{S1} ⊕ K_{S2}′.
Step 170 Client calculates the session key as K_{S}′=K_{S1}′ ⊕ K_{S2}. K_{S}′ should be identical to K_{S}.

Alternatively, server can calculate the session key as K_{S}=E_{Ks1}(K_{S2}′), and client can calculate the session key as K_{S}′=E_{Ks1′}(K_{S2}). K_{S}′ should be identical to K_{S}.

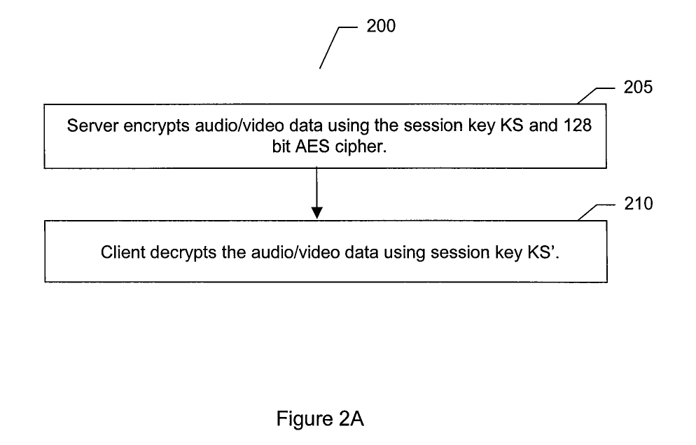

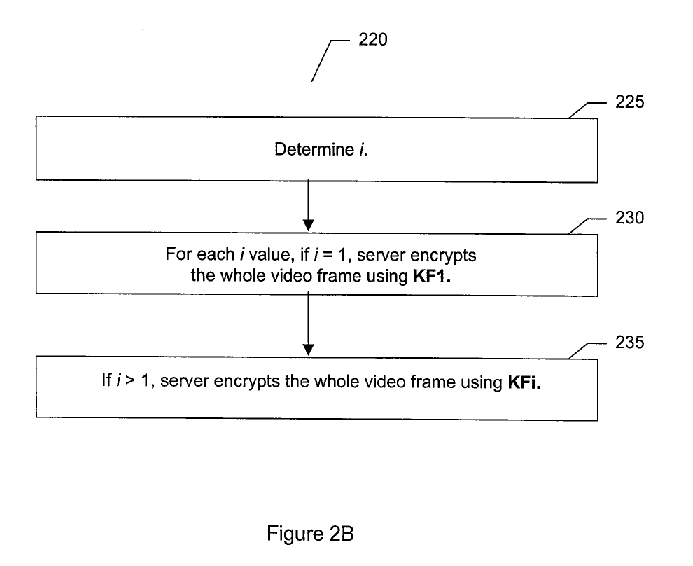

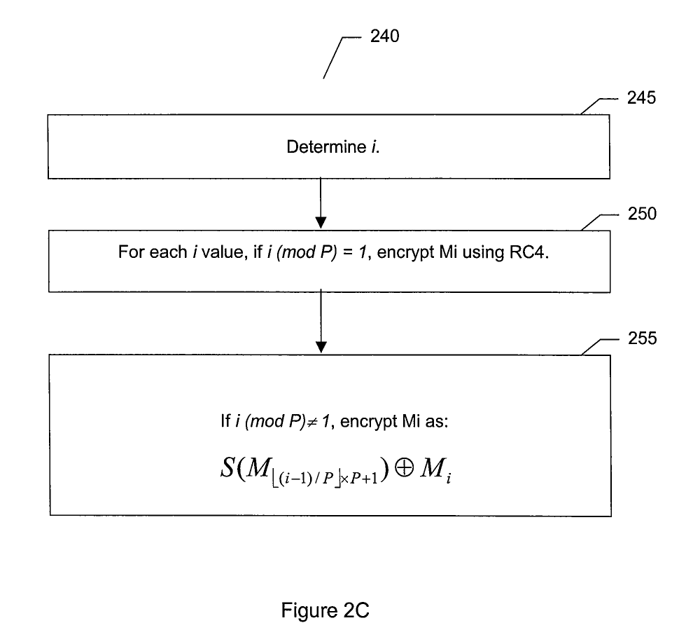

Refer to FIG. 2A, which is a flowchart illustrating a digital content encryption/decryption process 200 according to an embodiment of the present invention.

After the authentication 100 and session key establishment processes 160 illustrated in FIGS. 1B and 1C have successfully completed, the transmission of audio/video data can begin. The encryption/decryption process 200 comprises the following steps:
Step 205 Server encrypts audio/video data using the session key K_{S} and 128 bit AES cipher.
Step 210 Client decrypts the audio/video data using session key K_{S}′.

For high quality video, for example HDTV, the resolution can be very high, such as 1920×1080×30 fps. In this case, the uncompressed video stream could be very high in bitrate, around 120 MByte/sec. Thus, the payload encryption method described in FIG. 2A would require both server and client to have very high computing power. The fasted CPUs may not be fast enough, and GPUs on graphic cards are likely not fast enough to decrypt 120 Mbytes of data each second using AES decryption.

Therefore in an embodiment of the present invention an alternative method is utilized to encrypt the video payload. For each video frame, a 128 bit number K_{Fi} is generated using the following method, and K_{Fi} is used as the frame key to encrypt the iₜₕ video frame.

K_{F}_{₁}=E_{Ks}(1), for i=1

K_{F}_{ᵢ}=K_{F}_{_{i−1}} ⊕ E_{Ks}(K_{F}_{_{i−1}}), for i>1

The encryption/decryption method 220 illustrated in FIG. 2B comprises the following steps:
Step 225 Determine i.
Step 230 For each i value, if i=1, server encrypts the whole video frame using K_{F1}.
Step 235 If i>1, server encrypts the whole video frame using K_{Fi}.

In this embodiment the method to encrypt a video frame using K_{Fi} comprises using RC4 stream cipher to encrypt the whole video frame. RC4 is several times faster than AES. The benefit of this method is that RC4 is a well-established cipher that people trust.

Alternatively in cases where this method using RC4 is not fast enough, the present invention utilizes another method to encrypt a video frame.

Refer to FIG. 2C, which is a flowchart illustrating a digital content encryption/decryption process 240 according to an embodiment of the present invention. In this method the video frame is divided into macro-blocks, with each macro-block containing 16×16 pixels. In this embodiment the following symbols are defined as:

Mᵢ The iₜₕ macro-block in the video frame.

W The width of the video frame in terms of pixels.

H The height of the video frame in terms of pixels.

P A prime number which is also relatively prime to (W/16).

S(Mᵢ) Scramble Mᵢ using a very light-weight algorithm, for example 3 CPUcycle/byte.

The encryption method 240 comprises the following steps:

Step 245 Determine i.

Step 250 For each i value, if i (mod P)=1, encrypt Mᵢ using RC4.

Step 255 If i (mod P)≠1, encrypt Mᵢ as:

S(M_{└(i-1)/P┘×P+1}) ⊕ Mᵢ

This method is approximately P times faster than encrypting the whole video with RC4.

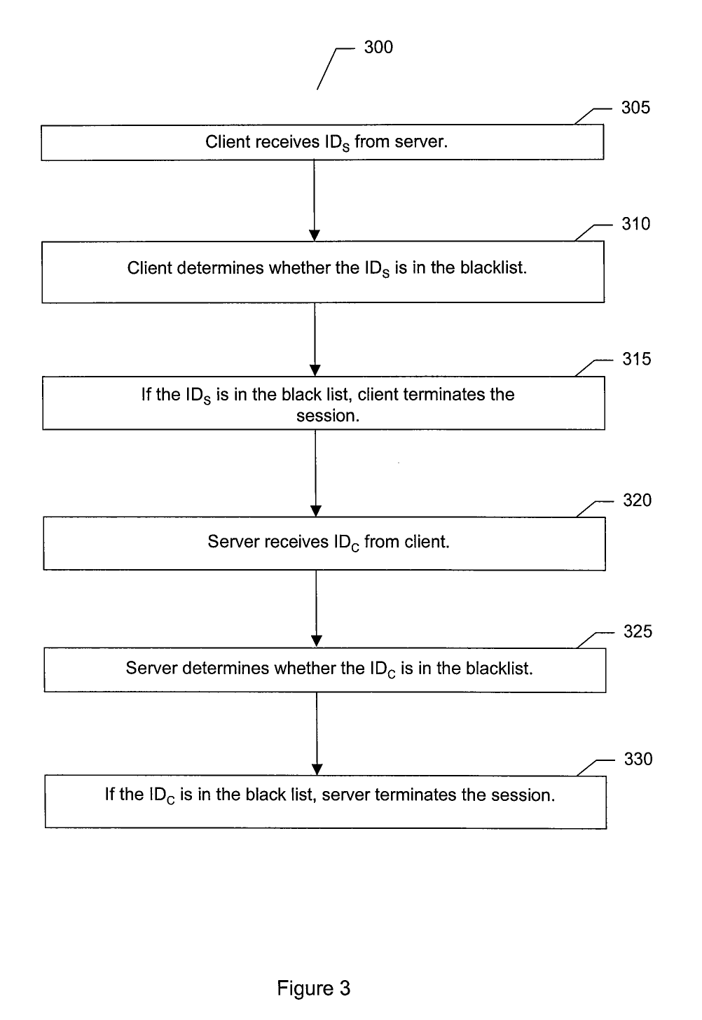

Refer to FIG. 3, which is a flowchart illustrating a revocation process 300 according to an embodiment of the present invention.

If a version of server or client is found to be compromised, its ID will be put into a blacklist. Every server and client contains this blacklist, and this list is updated periodically. The revocation process 300 illustrated in FIG. 3 comprises the following steps:

Step 305 Client receives ID_{S} from server.

Step 310 Client determines whether the ID_{S} is in the blacklist.

Step 315 If the ID_{S} is in the black list, client terminates the session.

Step 320 Server receives ID_{C} from client.

Step 325 Server determines whether the ID_{C} is in the blacklist.

Step 330 If the ID_{C} is in the black list, server terminates the session.

The client checks the blacklist before it sends data to server in Step 115 of FIG. 1B. The server checks the blacklist before it sends data to the client in Step 140 of FIG. 1B.

The present invention employs symmetric ciphers as its components. It should be noted that the method of the present invention can utilize various ciphers. For example, a 128 bit AES cipher can be used because its security is well trusted and it could be implemented in software with fast-computation and in hardware with low gate-count. Alternatively, the cipher could also be other ciphers, such as DES, Blowfish, or RC4, etc.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A digital content protection system comprising:
a client-server mutual authentication process comprising the steps of:
server notifies client to start the authentication process;
server sends random number R₁ and E_{C}(ID_{S} ⊕ R₁) to client, where E_{C} is encryption using a common key and ID_{S} is an identification number of the server;
client uses the common key to decrypt E_{C}(ID_{S} ⊕ R₁) into (ID_{S} ⊕ R₁), and then extracts ID_{S};
client uses ID_{S} to look up secret key pair K_{X1} and K_{X2};
client generates random numbers R₂ and K_{S2};
client uses encryption to generate R₂ ∥ E_{C}(ID_{C} ⊕ R₂) ∥ E_{Kx2}(R₁ ∥ K_{S2}), which the client sends to server, where ID_{C} is an identification number of the client and E_{Kx2} is encryption using secret key K_{X2};
server uses the common key to decrypt E_{C}(ID_{C} ⊕ R₂) into (ID_{C} ⊕ R₂), and then extracts ID_{C};
server uses ID_{C} to look up secret key pair K_{X1} and K_{X2};
server uses K_{X2} to decrypt E_{Kx2}(R₁ ∥ K_{S2}) into (R₁′ ∥ K_{S2}′);
wherein, if R₁′ is not equal to R₁, authentication failed and server terminates;
server generates random number K_{S1};
server uses encryption to encrypt (R₂ ∥ K_{S1}) into E_{Kx1}(R₂ ∥ K_{S1}), which the server sends to client, where E_{Kx1} is encryption using secret key Kₓ₁;
client uses secret key K_{X1} to decrypt E_{Kx1}(R₂ ∥ K_{S1}) into (R₂′ ∥ K_{S1}′);
wherein, if R₂′ is not equal to R₂, authentication failed and client terminates; and
a session key establishment process comprising the steps of:
server calculates session key as K_{S}=K_{S1} ⊕ K_{S2}′; and
client calculates session key as K_{S}′=K_{S1}′ ⊕ K_{S2};
wherein K_{S}′ is identical to K_{S}.

2. The digital content protection system of claim 1, further comprising:
a data encryption and decryption process comprising the steps of:
server encrypts audio/video data using session key K_{S} and a cipher; and
client decrypts the audio/video data using session key K_{S}′.

3. The digital content protection system of claim 1, where client uses AES encryption to generate R₂ ∥ E_{C}(ID_{C} ⊕ R₂) ∥ E_{Kx2}(R₁ ∥ K_{S2}).

4. The digital content protection system of claim 1, where server uses AES encryption to encrypt (R₂ ∥ K_{S1}) into E_{Kx1}(R₂ ∥ K_{S1}).

5. The digital content protection system of claim 2, where the audio/video data is encrypted using the following steps:
for each video frame, a 128 bit number K_{Fi} is generated using:
K_{F}_{₁}=E_{Ks}(1), for i=1
K_{F}_{ᵢ}=K_{f}_{_{i−1}} ⊕ E_{Ks}(K_{F}_{_{i−1}}), for i>1
where a frame key of the iₜₕ frame is called K_{Fi} and the iₜₕ frame is encrypted using K_{Fi}.

6. The digital content protection system of claim 2, where the audio/video data is encrypted using the following steps:
divide a video frame into macro-blocks;
for each i value, if i (mod P)=1, encrypt Mᵢ using RC4; and
if i (mod P)≠1, encrypt Mᵢ as:
S(M_{└(i-1)/P┘×P+1}) ⊕ Mᵢ
where Mᵢ is the iₜₕ macro-block in the video frame, W is a width of the video frame in terms of pixels, H is a height of the video frame in terms of pixels; P is a prime number which is also relatively prime to (W/16), and S(Mᵢ) scrambles Mᵢ using a light-weight algorithm.

7. The digital content protection system of claim 1, further comprising:
a revocation process using a blacklist of compromised servers and clients, the process comprising the steps of:
client receives ID_{S} from server;
client determines whether the ID_{S} is in the blacklist; and
if the ID_{S} is in the black list, client terminates communication with the server;
server receives ID_{C} from client;
server determines whether the ID_{C} is in the blacklist;
if the ID_{C} is in the black list, server terminates communication with the client.

8. A digital content protection system comprising:
a client-server mutual authentication process comprising the steps of:
server notifies client to start the authentication process;
server sends random number R₁ and E_{C}(ID_{S} ⊕ R₁) to client, where E_{C} is encryption using a common key and ID_{S} is an identification number of the server;
client generates random numbers R₂ and K_{S2};
client uses encryption to generate R₂ ∥ E_{C}(ID_{C} ⊕ R₂) ∥ E_{Kx2}(R₁ ∥ K_{S2}), which the client sends to server, where ID_{C} is an identification number of the client and E_{Kx2} is encryption using secret key Kₓ₂;
server uses the common key to decrypt E_{C}(ID_{C} ⊕ R₂) into (ID_{C} ⊕ R₂), and then extracts ID_{C};
server uses ID_{C} to look up secret key pair K_{X1} and K_{X2};
server uses K_{X2} to decrypt E_{K}ₓ₂(R₁ ∥ K_{S2}) into (R₁′ ∥ K_{S2}′);
wherein, if R₁′ is not equal to R₁, authentication failed and server terminates;
server generates random number K_{S1};
server uses encryption to encrypt (R₂ ∥ K_{S1}) into E_{Kx1}(R₂ ∥ K_{S1}), which the server sends to client, where E_{Kx1} is encryption using secret key Kₓ₁;
client uses secret key K_{X1} to decrypt E_{Kx1}(R₂ ∥ K_{S1}) into (R₂′ ∥ K_{S1}′);
wherein, if R₂′ is not equal to R₂, authentication failed and client terminates;
a session key establishment process comprising the steps of:
server calculates session key as Kₛ=K_{S1} ⊕ K_{S2}′; and
client calculates session key as K_{S}′=K_{S1}′ ⊕ K_{S2};
wherein K_{S}′ is identical to K_{S}; and
a data encryption and decryption process comprising the steps of:
server encrypts audio/video data using session key K_{S} and a cipher in electronic code book mode; and
client decrypts the audio/video data using session key K_{S}′.

9. The digital content protection system of claim 8, where client uses AES encryption to generate R₂ ∥ E_{C}(ID_{C} ⊕ R₂) ∥ E_{Kx2}(R₁ ∥ K_{S2}).

10. The digital content protection system of claim 8, where server uses AES encryption to encrypt (R₂ ∥ K_{S1}) into E_{Kx1}(R₂ ∥ K_{S1}).

11. The digital content protection system of claim 8, where the audio/video data is encrypted using the following steps:
for each video frame, a 128 bit number K_{Fi} is generated using:
K_{F}_{₁}=E_{Ks}(1), for i=1
K_{F}_{ᵢ}=K_{F}_{_{i−1}} ⊕ E_{Ks}(K_{F}_{_{i−1}}), for i>1
where a frame key of the iₜₕ frame is called K_{Fi} and the iₜₕ frame is encrypted using K_{Fi}.

12. The digital content protection system of claim 8, where the audio/video data is encrypted using the following steps:
divide a video frame into macro-blocks;
for each i value, if i (mod P)=1, encrypt Mᵢ using RC4; and
if i (mod P)≠ 1, encrypt Mᵢ as:
S(M└(i−1)/P┘×P+1) ⊕ Mᵢ
where Mᵢ is the iₜₕ macro-block in the video frame, W is a width of the video frame in terms of pixels, H is a height of the video frame in terms of pixels; P is a prime number which is also relatively prime to (W/16), and S(Mᵢ) scrambles Mᵢ using a light-weight algorithm.

13. The digital content protection system of claim 8, further comprising:
a revocation process using a blacklist of compromised servers and clients, the process comprising the steps of:
server receives ID_{C} from client;
server determines whether the ID_{C} is in the blacklist;
if the ID_{C} is in the black list, server terminates communication with the client;
client receives ID_{S} from server;
client determines whether the ID_{S} is in the blacklist; and
if the ID_{S} is in the black list, client terminates communication with the server.

14. A digital content protection system comprising:
a client-server mutual authentication process comprising the steps of:
server notifies client to start the authentication process;
server sends random number R₁ and E_{C}(ID_{S} ⊕ R₁) to client, where E_{C} is encryption using a common key and ID_{S} is an identification number of the server;
client generates random numbers R₂ and K_{S2};
client uses encryption to generate R₂ ∥ E_{C}(ID_{C} ⊕ R₂) ∥ E_{Kx2}(R₁ ∥ K_{S2}), which the client sends to server, where ID_{C} is an identification number of the client and E_{Kx2} is encryption using secret key Kₓ₂;
server uses the common key to decrypt E_{C}(ID_{C} ⊕ R₂) into (ID_{C} ⊕ R₂), and then extracts ID_{C};
server uses ID_{C} to look up secret key pair K_{X1} and K_{X2};
server uses K_{X2} to decrypt E_{Kx2}(R₁ ∥ K_{S2}) into (R₁′ ∥ K_{S2}′);
wherein, if R₁′ is not equal to R₁, authentication failed and server terminates;
server generates random number K_{S1};
server uses encryption to encrypt (R₂ ∥ K_{S1}) into E_{Kx1}(R₂ ∥ K_{S1}), which the server sends to client, where E_{Kx1} is encryption using secret key Kₓ₁;
client uses secret key K_{X1} to decrypt E_{Kx1}(R₂ ∥ K_{S1}) into (R₂′ ∥ K_{S1}′);
wherein, if R₂′ is not equal to R₂, authentication failed and client terminates;
a session key establishment process comprising the steps of:
server calculates session key as K_{S}=K_{S1} ⊕ K_{S2}′; and
client calculates session key as K_{S}′=K_{S1}′ ⊕ K_{S2};
wherein K_{S}′ is identical to K_{S};
a data encryption and decryption process comprising the steps of:
server encrypts audio/video data using session key K_{S} and a cipher in electronic code book mode; and
client decrypts the audio/video data using session key K_{S}′; and
a revocation process using a blacklist of compromised servers and clients, the revocation process comprising the steps of:
server receives ID_{C} from client;
server determines whether the ID_{C} is in the blacklist;
if the ID_{C} is in the black list, server terminates communication with the client;
client receives ID_{S} from server;
client determines whether the ID_{S} is in the blacklist; and
if the ID_{S} is in the black list, client terminates communication with the server.

15. The digital content protection system of claim 14, where the audio/video data is encrypted using the following steps:
for each video frame, a 128 bit number K_{Fi} is generated using:
K_{F}_{₁}=E_{Ks}(1), for i=1
K_{F}_{₁}=K_{F}_{_{i−1}} ⊕ E_{Ks}(K_{F}_{_{i−1}}), for i>1
where a frame key of the iₜₕ frame is called K_{Fi} and the iₜₕ frame is encrypted using K_{Fi}.

16. The digital content protection system of claim 15, where client uses AES encryption to generate R₂ ∥ E_{C}(ID_{C} ⊕ R₂) ∥ E_{Kx2}(R₁ ∥ K_{S2}).

17. The digital content protection system of claim 15, where server uses AES encryption to encrypt (R₂ ∥ K_{S1}) into E_{Kx1}(R₂ ∥ K_{S1}).

18. The digital content protection system of claim 15, where the audio/video data is encrypted using an RC4 stream cipher to encrypt a whole video frame.

19. The digital content protection system of claim 15, where the audio/video data is encrypted using an AES cipher.

20. The digital content protection system of claim 15, where the audio/video data is encrypted using the following steps:
divide a video frame into macro-blocks;
for each i value, if i (mod P)=1, encrypt Mᵢ using RC4; and
if i (mod P)≠1, encrypt Mᵢ as:
S(M└_{(i-1)/P┘×P+1}) ⊕ Mᵢ
where Mᵢ is the iₜₕ macro-block in the video frame, W is a width of the video frame in terms of pixels, H is a height of the video frame in terms of pixels; P is a prime number which is also relatively prime to (W/16), and S(Mᵢ) scrambles Mᵢ using a light-weight algorithm.
